(19) United States
(12) Patent Application Publication
(10) Pub. No.: US 2019/0251458 A1
(43) Pub. Date: Aug. 15, 2019

(54) SYSTEM AND METHOD FOR PARTICLE SWARM OPTIMIZATION AND QUANTILE REGRESSION BASED RULE MINING FOR REGRESSION TECHNIQUES

(71) Applicant: INSTITUTE FOR DEVELOPMENT AND RESEARCH IN BANKING TECHNOLOGY, Hyderabad (IN)

(72) Inventors: VADLAMANI RAVI, Hyderabad (IN); GUTHA JAYA KRISHNA, Hyderabad (IN); RAJA KUMAR DUBEY, Hyderabad (IN)

(21) Appl. No.: 16/020,972

(22) Filed: Jun. 27, 2018

(30) Foreign Application Priority Data
Feb. 15, 2018 (IN) 201841005863

(51) Int. Cl. G06N 5/04; G06F 17/18; G06N 99/00

(52) U.S. Cl. CPC G06N 5/046; G06N 99/005; G06F 17/18

(57) ABSTRACT

The embodiments herein disclose a system and method for particle swarm optimization and quantile regression-based rule mining for analyzing data sets involving only continuous explanatory variables. The system discloses an architecture for PSO based quantile regression rule mining for determining the prediction intervals (PIs). The system generates ‘if-then’ rules that yield PIs while solving a multiple regression problem having only continuous explanatory variables. The system performs an ensembling process to reduce the size of the rule base to a manageable number based on the quality metrics of prediction intervals. The system comprises a data set, and a rule miner designed to divide the data into deciles based on the descending order of the target attribute variable. PSO is invoked to derive a set of rules for each decile and capture the heteroscedasticity of the distribution of the data with the help of quantile regression, in a non-traditional way.

### CROSS-REFERENCE TO RELATED APPLICATIONS

The embodiments herein claim the priority of the Indian Provisional Patent Application No. 201841005863 filed on Feb. 15, 2018 with the title “A SYSTEM AND METHOD FOR PARTICLE SWARM OPTIMIZATION AND QUANTILE REGRESSION BASED RULE MINING FOR REGRESSION”, and the contents of which is included entirely as reference herein.

### BACKGROUND

### Technical Field

The present invention is generally related to the field of data analysis and data mining. The present invention is particularly related to a system and method for analyzing dataset utilizing regression techniques. The present invention is more particularly related to a system and method for particle swarm optimization and quantile regression based rule mining for analyzing data sets.

### Description of Related Art

Regression is an important predictive data mining technique, which aims at predicting a continuous target variable based on independent input attributes. Regression models associate a measured output to a collection of measured variables, each of which is believed to contribute to the output. Such regression models are widely used in various science, engineering, behavioral science, biostatistics, business, econometrics, financial engineering, insurance, medicine, and petroleum engineering applications. A regression model relates output Y to a function of X and β, where Y=f(X, β), where β are the unknown parameters, which represent a scalar or a vector X is the independent variable, and Y is the dependent variable.

Implementing a regression model introduces a variety of challenges, including the selection of variables, the selection of terms (also known as the regressors), selecting how many terms (hereinafter “Rₛ”) to include in the model, and optimizing the parameters that complete the description of the model. In real world applications, the specific nature of non-linear dependencies are usually unknown before the development of a regression model, and as such, the nonlinear dependencies are oftentimes chosen as combinations of linear products of variables, for example, two or three at a time. Additionally, the selection of Rₛ is typically performed, tediously, by trial and error. Furthermore, each term is a parametric function of variables wherein numerical values are specified for all such parameters. If, for example, exponential functions are used for each term, then numerical values for each exponent must also be provided.

Several models have been proposed for solving regression task ranging from neural networks to the state of the art evolutionary computing techniques. However, the existing predictive models have issues including interpretability and accuracy. In the existing predictive models, there is a trade-off between the performance measures of accuracy and the interpretability.

Conventional models produce an equation to represent a relationship between a dependent target variable and the independent input attributes. The equation ranges from a simple linear equation to a complex non-linear equation that is difficult for the end user to interpret. For example, the models built using neural networks through black boxes are designed to perform very well as far as accuracy is concerned but failed on the performance metric of interpretability.

Rule based mining helps to solve such issues in a better manner. Rule based mining is a procedure for processing and mining a set of logical statements from the given data for explaining a complete data in much simpler words. Rule mining for regression task aims at creating a set of logical conditional statements, which if satisfied, generates a conclusive evidence about the expected target variable. Basically the output of such rule mining, are a set of IF-THEN rules. Rules are supposed to have two parts, known as the antecedent part i.e. IF, and the consequent part i.e. THEN. The antecedent part consists of a set of conditions on the independent input attribute's value, and the consequent part indicates the dependent target variable's value, which is used only if the antecedent part is satisfied. Rules of these kinds (IF-THEN), are designed to generate a general relationship between the instances and their outcomes. These (IF-THEN) kind of rules are easily interpreted and found to be more comprehensive and more transparent than a general equation or a black box technique. Along with accuracy, these IF-THEN rules provide interpretability and comprehensibility. These IF-THEN rules are directly used by the experts for validation in various domains. Such IF-THEN rules are beneficial for experts who aim to understand real life scenarios like Fraud Detection, Medical Diagnosis, Bankruptcy Prediction, Credit Scoring based loan approval, Churn Predictions, etc.

Rule based mining for classification is quite successful in all types of applications, but for regression, it is still in a developing phase. Most of the models have more rules in the rule base or their accuracy is low. Sometimes they fail to accommodate noise/outliers in the data. Some of the models try to imitate classification by binning the continuous target attributes and assigning class labels. To generate rules, some models employ Particle Swarm Optimization (PSO) and Ant Colony Optimization (ACO) with sequential covering scheme. Besides the use of evolutionary computing, there are few models, which hybridize Support Vector Regression (SVR) with Classification And Regression Tree (CART) and with Dynamic Evolving Neuro-Fuzzy Inference System (DENFIS) also for regression tasks. Some models are designed to use static discretization while some other models are designed to dynamically form a region around predicted target value. Regression Based on Association (RBA) with new pruning schemes also exist in the literature.

An evolutionary computing and swarm intelligence based optimization problem, provides a viable alternative to traditional data mining techniques. Conventional regression techniques (black boxes like Neural Networks) predict a continuous output variable. However, the result of such models is less comprehensible. And certain technology domains require a comprehensible and transparent model which provides deeper insight about the dependence of output variable on attributes or predictor or explanatory variables.

Hence, there is a need for an improved method to generate if-then rules that can explain the relation between input variables and the output variable. Further, there is need for an improved rule mining technique using PSO for regression tasks. There is also a need for a system and method for generating a set of rules (if-then rules) describing a dataset using PSO based regression miner. Still further, there is a need for a system and method for providing a correlation coefficient-based prediction of the target variable with the help of PSO. Yet there is a need for a system and method for integrating quadrumvirate comprising particle swarm optimization with mixed encoding, quantile regression, prediction intervals (PIs) and ensembling process in a seamless manner. Yet there is a need for a system and method for generating an architecture for PSO based quantile regression rule mining for estimating/determining the PIs. Yet there is a need for a system and method for ensembling all the rule bases to reduce the rule base to a manageable number based on the metrics of prediction intervals. Yet there is a need for a system and method for rule extraction with new rule encoding, with the use of statistical properties, decile wise sequential covering scheme and prediction intervals for incorporating uncertainties.

The above mentioned shortcomings, disadvantages and problems are addressed herein, which will be understood by reading and studying the following specification.

### OBJECTIVES OF THE EMBODIMENTS

The primary object herein is to provide a system and method generating particle swarm optimization (PSO) and quantile regression-based rule miner for regression problems.

Another object herein is to provide a system and method for generating ‘if-then’ rules based on particle swarm optimization with mixed encoding.

Yet another object herein is to provide a system and method for integrating particle swarm optimization with quantile regression techniques, prediction intervals (PIs) and ensembling in a seamless manner.

Yet another object herein is to provide a system and method-utilizing PSO based regression miner to generate a set of rules describing a dataset.

Yet another object herein is to provide a system and method for estimating correlation coefficient-based prediction of the target variable using PSO to quicken the process without compromising on accuracy of the process.

Yet another object herein is to provide an architecture for PSO based quantile regression rule mining for estimating the PIs.

Yet another object herein is to provide a system and method for performing an ensembling process to reduce the rule base to a manageable number based on the metrics of prediction intervals.

Yet another object herein is to provide a system and method for estimating prediction intervals by employing if-then rules based quantile regression techniques.

Yet another object herein is to provide a system and method for solving a regression problem using quadrumvirate comprising a particle swarm optimization with mixed encoding, quantile regression, prediction intervals, and ensembling techniques in a seamless manner.

Yet another object herein is to provide a system and method for estimating/constructing prediction intervals in an intuitive and simple manner without employing any complex processes.

Yet another object herein is to provide a system and method for estimating a set of performance measures such as Prediction Goodness, PINAW, PICP, and other metrics like number of rules generated as well as average rule length for each model to analyze the results of each model.

Yet another object herein is to provide a system and method for models to have good accuracy (PG) and good PIs (high PICP and narrow PINAW).

Yet another object herein is to provide a system and method for generating a final rule base with a less number of rules of smaller rule length.

Yet another object herein is to provide a system and method for utilizing better techniques for selecting rules to achieve high PICP and low PINAW.

Yet another object herein is to provide a system and method for dividing data sets in deciles by employing PSO.

Yet another object herein is to provide a system and method for performing quantile regression in an intuitive and simple manner.

Yet another object herein is to provide a system and method for ensembling all the rule bases to reduce the rule base to a manageable number based on the metrics of prediction intervals.

Yet another object herein is to provide a system and method for rule extraction with new rule encoding, with the use of statistical properties, decile wise sequential covering scheme and prediction intervals for incorporating uncertainties.

Yet another object herein is to provide a system and method for estimating Pearson correlation coefficient based prediction of the target variable with the help of Particle swarm optimization

These and other objects and advantages herein will become readily apparent from the following detailed description taken in conjunction with the accompanying drawings.

### SUMMARY

The various embodiments herein disclose an improved method to generate if-then rules that can explain the relation between input data and the output results. The embodiments herein disclose a method and system for Pearson correlation coefficient-based prediction of the target variable with the help of Particle swarm optimization. Thus, the system provides an approach to compute prediction interval without compromising the accuracy. The embodiment herein discloses an intuitive method of constructing prediction intervals. The system discloses an architecture for determining a final output of PSO based quantile regression rule mining for estimating/constructing the Prediction Intervals (PI). Further, the system generates ‘if-then’ rules that yield prediction intervals while solving a multivariate regression problem. The system provides ensembling based on the metrics of prediction intervals reduces the rule base to a manageable number. The system comprises a data set, and a rule miner configured to divide the data into deciles based on decreasing order of target attribute. Thereafter PSO is implemented to derive a set of rules for each decile and capture the heteroscedasticity of the distribution of the data from quantile regression implemented in a non-traditional way.

According to an embodiment herein, a computing device/system for implementing a particle swarm optimization (PSO) based regression model in a computing environment. The system/computing device comprises a hardware processor coupled to a memory containing instructions configured for generating IF-THEN rules along with estimating prediction intervals of a data set, wherein the hardware processor is configured to receive the historical data set including a plurality of input variables and a single output variable. The computing device includes an initializing module configured to segregate the data set into a training data set often deciles and a test data. The computing device includes an objective function evaluation module to determine a first objective function for the training data, and wherein the objective function is configured to judge a fitness of each data item in the data input. The computing device includes a rule miner module configured to determine a set of rules for encoding, and wherein the set of rules are stored in a rule base. The rule miner module is configured to execute a particle swarm optimization-based quantile regression on the dataset for a predefined number of times to generate a set of rule bases. The set of rule bases are stored in a database as combined rule base. The computing device includes an ensembling module to ensemble the set of rules from the combined rule base with a threshold of one percent on coverage from a combined rule base. In other words, rules with coverage falling below 1% threshold are removed. The computing device includes a prediction interval calculator module configured to estimate prediction intervals associated with the data set using the rule.

According to an embodiment herein, the rule miner module is further configured to generate a rule Rₚ covering Cₚ samples of the training dataset decile using PSO rule miner; and add each rule Rₚ to the rule base.

According to an embodiment herein, the objective function evaluation module is configured to analyze the results of the two generated models using a set of performance measures. The set of performance measures includes Prediction Goodness, PINAW, PICP, and other metrics like the number of rules generated as well as the average rule length for each model. The first objective function is configured to generate less number of rules having high PG, high and consistent PICP and very less PINAW. The second objective function is configured to generate rules with slightly less PG, low PICP, and more PINAW than the first objective function. A threshold is applied on over fitting rules to improve the results thereby decreasing the number of rules and PINAW without much change in prediction goodness and PICP.

The objective function evaluation module is further configured to select an antecedent part of the rule to determine coverage; select a consequent part of the rule to determine predicted target values for samples covered by the rule in each decile of the dataset covered by the rule; compute a first Pearson correlation coefficient for each attribute with a predicted target variable for samples covered by the rule in each decile of the dataset; compute a second Pearson correlation coefficient for each attribute with an actual target variable for samples covered by the rule in each decile of the dataset; determine whether the total number of times the difference between the first Pearson correlation coefficient and the second Pearson correlation coefficient becomes less than a pre-specified threshold; and thereby determine a fitness of each particle.

According to an embodiment herein, the objective function evaluation module is configured to select an antecedent part of the rule to determine coverage; select a consequent part of the rule to determine predicted target values for samples covered by the rule in each decile of the dataset; compute a first Pearson correlation coefficient for each attribute with a predicted target variable for samples covered by the rule in each decile of the dataset; compute a second Pearson correlation coefficient for each attribute with an actual target variable for samples covered by the rule in each decile of the dataset; determine a total number of times the difference between the first Pearson correlation coefficient and the second Pearson correlation coefficient becomes less than a pre-specified threshold; compute a Mean Squared Error (MSE) between the predicted target values and the actual target values for all samples, wherein the samples belong to the antecedent part of the rule; and determine a fitness as a difference between the normalized sum and the mean square error.

According to an embodiment herein, the rule miner module is further configured to initialise particles, and wherein a best state for a particle is initialized as P_{best} and a particle with highest fitness in the population is initialized as G_{best}; compute a fitness function for each particle using at least one of the first objective function and the second objective function; determine whether the computed fitness for each particle is better than the best state of particle P_{best}; update the best state of particle P_{best} when the computed firtness is better than initial P_{best}; update velocity and position of each particle; determine the particle with minimum Prediction Interval Normalized Average Width (PINAW) and maximum (Prediction Interval Coverage Probability) PICP for selecting the best particle in the population; and determine the best rule based on PINAW and PICP values.

According to an embodiment herein, the prediction interval calculator module is further configured to compute the coverage of each rule in the rule base, wherein the coverage is determined by selecting a part of the train data set that follows the antecedent part of rule; determine predicted target values Yᵢ* for each sample present in the set using the consequent part of rule; compute mean (μ) and standard deviation (σ) of all the extracted predicted target value; and estimate a prediction interval for output variable of the samples covered by the rule as [(μ−σ), (μ+σ)].

According to an embodiment herein, the ensembling module is further configured to eliminate the rules in the rule base with coverage less than one percent of a total number of samples in the entire dataset to form the ensembled rules.

According to an embodiment herein, the database stores a set of rules, combined rule base, and ensembled rules.

According to one embodiment herein, a system and method is provided to develop/generate a PSO based regression miner, which utilizes the concept of sequential covering and generates a set of rules for indicating an entire dataset. The system is first configured to divide the sorted data set into ten equal deciles and then utilize the concept of separate-and-conquer to generate a set of rules for each decile. PSO is used for the purpose of rule generation. The system is further configured to generate a set of rule encoding and objective functions, which together generate/form a set of simple and comprehensible rules with good accuracy. An objective function is configured to judge a fitness of each data item. The system is configured to optimize the objective function. The system is configured to compare two different objective functions. Model-1 is developed to use the objective function based on Pearson correlation coefficient, while the Model-2 is developed to utilize both the Pearson correlation coefficient and MSE (mean squared error). The system is configured to estimate and use the prediction intervals to incorporate the uncertainties associated with point forecasts. The entire process is executed for a preset number of times for nullifying the effect of seed and the set of rules generated for each decile from each execution is ensembled. A threshold value on coverage is computed to remove over fitting rules such that the minimum number of samples denoted by each rule is larger than 1% of the total samples present in the dataset. Finally, a sufficient set of unique and simple rules of small rule length, is generated/derived to denote/indicate the test data more accurately.

According to the present invention, the data is divided into deciles based on decreasing order of target attribute and PSO is implemented to derive a set of rules for each decile and capture the heteroscedasticity of the distribution of the data from quantile regression, implemented in a non-traditional way.

According to an embodiment herein, Quantile Regression deals with the issue of heteroscedasticity in the data. Quantile Regression is designed to fit multiple regression curves to capture the entire distribution of the data, as all the modalities of the entire distribution of the data is not captured by a single regression curve. The data is divided into multiple quantiles and then each quantile is fit with a regression curve.

According to an embodiment herein, the data is divided into deciles based on a decreasing order of target attribute and a set of rules is created for each decile thereby making the convergence of PSO faster as well as capturing the heteroscedasticity of the distribution of the data.

According to one embodiment herein, PSO is applied to each quantile of data to obtain a set of rules capturing heteroscedasticity of the distribution of the data.

According to an embodiment herein, the PSO is configured to imitate the behavior of particles in a swarm. Each individual in the swarm is called a particle and it represents a possible solution vector. Each particle has a position (X) and a velocity (V) denoting the present position of the particle as well as a direction of movement respectively. The fitness of each particle is judged by an objective function which is to be optimized. Each particle has a memory and is designed/configured to remember its personal best state P_{best} (a state with the best fitness) and the best state achieved by all the particles till now in the swarm known as G_{best}.

According to the present invention, the Prediction Intervals (PI) are designed to incorporate uncertainties of point predictions in an excellent manner.

According to an embodiment herein, the effect of velocity at t^{th} iteration on the velocity at (t+1)^{th} iteration is determined by an inertia weight, while the effect of exploration and exploitation on the movement of particles is determined by c₁ and c₂. Every particle is tend to move towards its local best position as well as the global best position of all particles in the swarm thereby ensuring that particles are not stuck in local optima. The random movement of the particle converges at last, giving us the global best.

According to one embodiment herein, Prediction Intervals (PI) are used to incorporate uncertainties of point predictions. The parameters/criteria used to estimate/judge a quality of PI are Prediction Interval Coverage Probability (PICP) and Prediction Interval Normalized Average Width (PINAW). Prediction Interval Coverage Probability (PICP) refers to the percentage of Probability targets which fall in the proposed Prediction Intervals. Higher the PICP better the PI. Mathematically, PICP is represented as

PICP=1/NΣₜ₌₁^{N}cₜ

cₜ=1;yₜ∈[Lₜ,Uₜ]

cₜ=0;yₜ∉[Lₜ,Uₜ]

where Uₜ and Lₜ represent the upper boundary/limit and lower boundary/limit of a predicted interval, and N is a total number of samples for which prediction is estimated.

According to one embodiment herein, Prediction Interval Normalized Average Width (PINAW) represents the average width of the PI. When PICP is high, the PINAW is reduced accordingly. Mathematically, PINAW is represented as

$$PINAW = \frac{1}{NR} {\sum }_{t = 1}^{N} ( {L}_{t} - {U}_{t} )$$

Where Uₜ and Lₜ represent the upper boundary/limit and lower boundary/limit of a predicted interval, and N is a total number of samples for which prediction is done, and R is the range of actual output variable values of all the samples in the coverage.

According to one embodiment herein, Rule Encoding is performed for training the samples present in the decile using the techniques such as Michigan approach. The rule encoding is of length (3*A+N), where A is the number of attributes, and N represents the number of samples present in the training decile is displayed in Table.1 given below.

TABLE 1
Rule Encoding

| | |
|---|---|
| Antecedent Part ((3*A) bits) | Consequent Part (N bits) |

According to one embodiment herein, the antecedent part is of length 3*A. For each attribute, 3 bits are provided. The first bit is a continuous value representing the benchmark value of the given attribute. The second bit indicates whether the respective attribute's value is greater than or equal to or less than the first bit value/benchmark. The third bit, decides whether the attribute is included in the rule or not.

TABLE 2
Rule Encoding for the Antecedent

| | | |
|---|---|---|
| Benchmark | ≥ or < | 0 or 1 |

TABLE 3
Antecedent part of the rule expanded

| Dimension 1 | | | Dimension 2 | | | Dimension 3 | | | - - - | | | Dimension A | | |
|---|---|---|---|---|---|---|---|---|---|---|---|---|---|---|
| 0.5 | 0.7 | 1 | 0.3 | 0.4 | 0 | 0.7 | 0.9 | 1 | . . . | . . . | . . . | 0.2 | 0.7 | 1 |

The antecedent part of the rule encoding for each attribute consist of three bits, of which two are continuous bits and one is a discrete bit. So, a PSO with mixed encoding for continuous as well as discrete bits is used for 3*A+N values.

According to one embodiment herein, the first two bits lies between [0,1]. When the value of second bit is greater than 0.5 then corresponding attribute value is considered less than the benchmark. When the value of second bit is equal to or less than 0.5 then corresponding attribute value is more than or equals to the benchmark. The value of the third bit will be either 0 or 1. When the third bit is 1 then that attribute is included in the rule or else not.

TABLE 4
Consequent part of the rule expanded

| | | | | |
|---|---|---|---|---|
| Predicted | Predicted | Predicted target | • • • | Predicted target |
| target | target | value of 3^{rd} sample | | value of N^{th} sample |
| value of | value of | | | |
| 1^{st} sample | 2^{nd} sample | | | |

According to one embodiment herein, the consequent part of the rule is of length N. Each of the N bits is configured to hold the predicted values of the target for each sample in the training dataset. Out of N bits, PSO is configured to generate predicted target values for only those samples which are covered by a preset rule so that the samples strictly follow the antecedent part of the rule. Rest of the bits remains constant and has zero (no/nil) contribution in the generation of Prediction Interval.

According to one embodiment herein, quantile regression is used to control the division of samples into deciles and sequential calling of PSO for the training dataset. Each rule has one antecedent part and one consequent part. For objective function-1, the antecedent part of the rule is used to determine the coverage, so that the samples strictly satisfying the antecedent part are determined. Further, the consequent part of the rule to achieve the predicted target values for these samples are computed. Consequently, the Pearson correlation coefficient between the attributes and the predicted target values of the samples in the coverage is computed. Thereafter, the Pearson correlation coefficient between the attributes and the actual target values for the entire dataset is computed. Finally, the attribute wise difference between these two correlation vectors are determined/computed. When the computed difference is less than the threshold, then the SUM is incremented by 1 (Initially SUM is equal to 0).

According to one embodiment herein, a plurality of algorithms are provided respectively for quantile regression, PSO rule miner, computation of first objective function, computation of second objective function, computation of PI, and ensembling processes.

According to one embodiment herein, a prediction interval is associated with each rule/particle. Every rule has a coverage C consisting of c points. Using consequent part of the rule, the predicted values are extracted. To prevent uncertainties, Prediction Intervals are determined. For each rule, a PI is predicted. Further, a vector consisting of predicted target variable of all the samples covered by a rule is generated using an antecedent part. The mean and the standard deviation of all the elements in the vector are computed. Further, an interval (PI) within which the output values of all the samples covered by a rule lies is determined. The interval is [(μ−σ), (μ+σ)], where μ is the computed mean of the elements of the vector and σ is the computed standard deviation of the elements of the vector. Thus, for each rule R, an interval of [(μ−σ), (μ+σ)] for the target/output variable of all the samples in test/train set, covered by the rule R is determined. So, the width of the proposed interval is chosen as 2*σ because it is small but at the same time it is large enough to have a high number of correct predictions. The sequence of steps involved in computation is as follows:
1. For each rule R, the coverage C of the rule R is computed, so that a set consisting of samples in the train set satisfies the antecedent part of rule R.
2. The predicted target values Yᵢ* for each sample present in the set C are extracted using the consequent part of rule.
3. Mean (μ) and standard deviation (σ) of all the extracted predicted target value Yᵢ* are computed.
4. An interval for target/output variable of the samples covered by the rule as [(μ−σ), (μ+σ)] is computed.

According to an embodiment herein, the system and method are provided to generate/develop a Particle Swarm Optimization and Quantile Regression based Rule Miner with Prediction intervals for Regression tasks. Initially, the samples/data set are divided into deciles and a sequential covering of PSO for the training dataset is performed. According to an embodiment herein, two models (first and second models) are generated respectively with a mutually different objective functions required to judge/estimate the fitness of each particle. The first objective function associated with the first model (Model-1) is configured to depend on the Pearson correlation coefficient. The second objective function associated with the second model (Model-2) is configured to depend on a Mean Squared Error (MSE) of the predicted target variables along with the Pearson correlation coefficient.

According to an embodiment herein, a method and system for Pearson correlation coefficient-based prediction of the target variable with the help of Particle swarm optimization is disclosed. Thus, the system provides an approach to compute prediction interval without compromising the accuracy. The present invention discloses an intuitive method of constructing prediction intervals. The system discloses an architecture for determining a final output of PSO based quantile regression rule miner for finding the Prediction Intervals (PI). Further, the system generates ‘if-then’ rules that yield prediction intervals while solving a multivariate regression problem. The system provides ensembling based on the metrics of prediction intervals reduces the rule base to a manageable number.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart explaining a method for computing the two objective functions to generate IF-THEN rules with prediction intervals for the dataset, according to one embodiment herein.

FIG. 2 is a flowchart explaining a method for finding the best rule using one of the two objective functions with the help of Particle Swarm Optimization, Quantile Regression and Prediction intervals for Regression problems, according to one embodiment herein.

FIG. 3 illustrates a functional block diagram of a system for generating Particle Swarm Optimization and Quantile Regression based Rule Miner with Prediction intervals for Regression problems using ensembling principle, according to one embodiment herein.

FIG. 4 is a flowchart illustrating a method involved in determining rules and prediction intervals in two variants i.e. with and without 1% threshold on coverage of rule for a given model (Model-1 and Model-2).

FIG. 5 illustrates a computing device/system for implementing a particle swarm optimization (PSO) based regression model in a computing environment.

FIG. 6A illustrates a chart indicating a comparison of performance measures of two models used in a method for generating Particle Swarm Optimization and Quantile Regression based Rule Miner with Prediction intervals for Regression problems, according to one embodiment herein.

FIG. 6B illustrates a chart indicating a comparison of performance measures of two models used in a method for generating Particle Swarm Optimization and Quantile Regression based Rule Miner with Prediction intervals for Regression problems in another exemplary embodiment.

FIG. 6C illustrates a chart indicating a comparison of Prediction Goodness, PICP and PINAW for two models with 1% threshold on coverage in an exemplary embodiment.

FIG. 6D illustrates a chart indicating a comparison of Prediction Goodness, PICP and PINAW for two models with 1% threshold on coverage in an exemplary embodiment.

FIG. 6E illustrates a chart indicating a comparison of Prediction Goodness, PICP and PINAW for two models with 1% threshold on coverage in an exemplary embodiment.

Although the specific features herein are shown in some drawings and not in others. This is done for convenience only as each feature may be combined with any or all of the other features in accordance with the present invention.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein disclose a method and system for Pearson correlation coefficient based prediction of the target variable with the help of particle swarm optimization (PSO). Thus, the system provides a faster approach to compute prediction interval without compromising the accuracy. The present invention discloses an intuitive method of constructing prediction intervals. The system discloses an architecture for determining a final output of PSO based quantile regression rule mining for estimating/constructing the Prediction Intervals (PI). Further, the system generates ‘if-then’ rules that yield prediction intervals while solving a multivariate regression problem. The system provides ensembling based on the metrics of prediction intervals that reduces the rule base to a manageable number. The system comprises a data set, and a rule miner configured to divide the data into deciles based on decreasing order of target attribute. Thereafter PSO is implemented to derive a set of rules for each decile and capture the heteroscedasticity of the distribution of the data from quantile regression, implemented in a non-traditional way.

According to an embodiment herein, a computing device/system for implementing a particle swarm optimization (PSO) based regression model in a computing environment is disclosed. The system/computing device includes a hardware processor coupled to a memory containing instructions configured for estimating prediction intervals of a data set, wherein the hardware processor is configured to receive the historical data set including a plurality of input variables and a single output variable. The computing device includes an initializing module configured to segregate the data set into a training data set of ten deciles and a test data. The computing device includes an objective function evaluation module to determine a first objective function for the training data, and wherein the objective function is configured to judge a fitness of each rule which covers of some data items in the data input. The computing device includes a rule miner module configured to determine a set of rules for encoding, and wherein the set of rules are stored in a rule base. The rule miner module is configured to execute a particle swarm optimization-based quantile regression on the dataset for a predefined number of times to generate a set of rule bases. The set of rule bases are stored in a database as combined rule base. The computing device includes an ensembling module to ensemble the set of rules from the combined rule base with a threshold of one percent on coverage from a combined rule base. The computing device includes a prediction interval calculator module configured to estimate prediction intervals associated with the data set using the rule.

According to an embodiment herein, the rule miner module is further configured to generate a rule Rₚ covering Cₚ samples of the training dataset decile using PSO rule miner; and add each rule Rₚ to the rule base.

According to an embodiment herein, the objective function evaluation module is configured to analyze the results of the two generated models using a set of performance measures. The set of performance measures includes Prediction Goodness, PINAW, PICP, and other metrics like the number of rules generated as well as the average rule length for each model. The first objective function is configured to generate less number of rules having high PG, high and consistent PICP and very less PINAW. The second objective function is configured to generate rules with slightly less PG, low PICP, and more PINAW than the first objective function. A threshold is applied on over fitting rules to improve the results thereby decreasing the number of rules and PINAW without much change in prediction goodness and PICP.

The objective function is further configured to select an antecedent part of the rule to determine coverage; select a consequent part of the rule to determine predicted target values for samples covered by the rule in each decile of the dataset; compute a first Pearson correlation coefficient for each attribute with a predicted target variable for samples covered by the rule in each decile of the dataset; compute a second Pearson correlation coefficient for each attribute with an actual target variable for samples covered by the rule in each decile of the dataset; determine whether a sum as total number of times the difference between the first Pearson correlation coefficient and the second Pearson correlation coefficient becomes less than a pre-specified threshold; and determine a fitness of each particle, wherein the fitness is the sum.

According to an embodiment herein, the objective function evaluation module is configured to select an antecedent part of the rule to determine coverage; select a consequent part of the rule to determine predicted target values for samples covered by the rule in each decile of the dataset; compute a first Pearson correlation coefficient for each attribute with a predicted target variable for samples covered by the rule in each decile of the dataset; compute a second Pearson correlation coefficient for each attribute with an actual target variable for samples covered by the rule in each decile of the dataset; determine a sum as total number of times the difference between the first Pearson correlation coefficient and the second Pearson correlation coefficient becomes less than a pre-specified threshold; compute a Mean Squared Error (MSE) between the predicted target values and the actual target values for all samples, wherein the samples belong to the antecedent part of the rule; determine a fitness as a difference between the normalized sum and the mean square error.

According to an embodiment herein, the rule miner module is further configured to initialise particles, wherein a best state for a particle is initialized as P_{best} and a particle with highest fitness in the population is initialized as G_{best}; compute a fitness function for each particle using at least one of the first objective function and the second objective function; determine whether the computed fitness for each particle is better than the best state of particle P_{best}; update the best state of particle P_{best}, when the computed firtness is better than initial P_{best}; update velocity and position of each particle; determine the particle with minimum Prediction Interval Normalized Average Width (PINAW) and maximum (Prediction Interval Coverage Probability) PICP for selecting the best particle in the population; and determine the best rule based on PINAW and PICP values.

According to an embodiment herein, the prediction interval calculator module is further configured to compute the coverage of each rule in the rule base, and wherein the coverage is determined by selecting a part of the train data set that follows the antecedent part of rule; determine predicted target values Yᵢ* for each sample present in the set using the consequent part of rule; compute mean (μ) and standard deviation (σ) of all the extracted predicted target value; and estimate a prediction for output variable of the samples covered by the rule as [(μ−σ), (μ+σ)].

According to an embodiment herein, the ensembling module is further configured to eliminate the rules in the rule base with coverage less than one percent of a total number of samples in the entire dataset to form the ensembled rules.

According to an embodiment herein, the database stores a set of rules, combined rule base, and ensembled rules.

According to one embodiment herein, a system and method is provided to develop/generate a PSO based regression miner, which utilizes the concept of sequential covering and generates a set of rules for indicating an entire dataset. The system is first configured to divide the sorted data set into ten equal deciles and then utilize the concept of separate-and-conquer to generate a set of rules for each decile. PSO is used for the purpose of rule generation. The system is further configured to generate a set of rule encoding and objective functions, which together generate/form a set of simple and comprehensible rules with good accuracy. An objective function is configured to judge a fitness of each data item. The system is configured to optimize the objective function. The system is configured to compare two different objective functions. Model-1 is developed to use the objective function based on Pearson correlation coefficient, while the Model-2 is developed to utilize both the Pearson correlation coefficient and MSE (mean squared error). The system is configured to estimate and use the prediction intervals to incorporate the uncertainties associated with point forecasts. The entire process is executed for a preset number of times for nullifying the effect of seed and the set of rules generated for each decile from each execution is ensembled. A threshold value on coverage is computed to remove over fitting rules such that the minimum number of samples denoted by each rule is larger than 1% of the total samples present in the dataset. Finally, a sufficient set of unique and simple rules of small rule length, is generated/derived to denote/indicate the test data more accurately.

According to the present invention, the data is divided into deciles based on decreasing order of target attribute and PSO is implemented to derive a set of rules for each decile and capture the heteroscedasticity of the distribution of the data from quantile regression.

According to an embodiment herein, Quantile Regression deals with the issue of heteroscedasticity in the data. Quantile Regression is designed to fit multiple regression curves to capture the entire distribution of the data, as all the modalities of the entire distribution of the data is not captured by a single regression curve. The data is divided into multiple quantiles and then each quantile is fit with a regression curve.

According to an embodiment herein, the data is divided into deciles based on a decreasing order of target attribute and a set of rules is created for each decile thereby making the convergence of PSO faster as well as capturing the heteroscedasticity of the distribution of the data.

According to one embodiment herein, PSO is applied to each quantile of data to obtain a set of rules capturing heteroscedasticity of the distribution of the data.

According to an embodiment herein, the PSO is configured to imitate the behavior of particles in a swarm. Each individual in the swarm is called a particle and it represents a possible solution vector. Each particle has a position (X) and a velocity (V) denoting the present position of the particle as well as a direction of movement respectively. The fitness of each particle is judged by an objective function which is to be optimized. Each particle has a memory and is designed/configured to remember its personal best state P_{best} (a state with the best fitness) and the best state achieved by all the particles till now in the swarm known as G_{best}.

According to an embodiment herein, the effect of velocity at t^{th} iteration on the velocity at (t+1)^{th} iteration is determined by an inertia weight, while the effect of exploration and exploitation on the movement of particles is determined by c₁ and c₂. Every particle is tend to move towards its local best position as well as the global best position of all particles in the swarm thereby ensuring that particles are not stuck in local optima. The random movement of the particle converges at last, giving us the global best.

According to the present invention, the Prediction Intervals (PI) are designed to incorporate uncertainties of point predictions in an excellent manner.

According to one embodiment herein, Prediction Intervals (PI) are used to incorporate uncertainties of point predictions. The parameters/criteria used to estimate/judge a quality of PI are Prediction Interval Coverage Probability (PICP) and Prediction Interval Normalized Average Width (PINAW). Prediction Interval Coverage Probability (PICP) refers to the percentage of Probability targets which fall in the proposed Prediction Intervals. Higher the PICP better the PI. Mathematically, PICP is represented as

PICP=1/NΣₜ₌₁^{N}cₜ

cₜ=1;yₜ∈[Lₜ,Uₜ]

cₜ=0;yₜ∉[Lₜ,Uₜ]

where Uₜ and Lₜ represent the upper boundary/limit and lower boundary/limit of a predicted interval, and N is a total number of samples for which prediction is estimated.

According to one embodiment herein, Prediction Interval Normalized Average Width (PINAW) represents the average width of the PI. When PICP is high, the PINAW is reduced accordingly. Mathematically, PINAW is represented as

$$PINAW = \frac{1}{NR} {\sum }_{t = 1}^{N} ( {L}_{t} - {U}_{t} )$$

Where Uₜ and Lₜ represent the upper boundary/limit and lower boundary/limit of a predicted interval, and N is a total number of samples for which prediction is done, and R is the range of actual output variable values of all the samples in the coverage.

According to one embodiment herein, Rule Encoding is performed for training the samples present in the decile using the techniques such as Michigan approach. The rule encoding is of length (3*A+N), where A is the number of attributes, and N represents the number of samples present in the training decile is displayed in Table.1 given below.

TABLE 1
Rule Encoding

| | |
|---|---|
| Antecedent Part ((3*A) bits) | Consequent Part (N bits) |

According to one embodiment herein, the antecedent part is of length 3*A. For each attribute, 3 bits are provided. The first bit is a continuous value representing the benchmark value of the given attribute. The second bit indicates whether the respective attribute's value is greater than or equal to or less than the first bit value/benchmark. The third bit, decides whether the attribute is included in the rule or not.

TABLE 2
Rule Encoding for the Antecedent

| | | |
|---|---|---|
| Benchmark | ≥ or < | 0 or 1 |

TABLE 3
Antecedent part of the rule expanded

| Dimension 1 | | | Dimension 2 | | | Dimension 3 | | | - - - | | | Dimension A | | |
|---|---|---|---|---|---|---|---|---|---|---|---|---|---|---|
| 0.5 | 0.7 | 1 | 0.3 | 0.4 | 0 | 0.7 | 0.9 | 1 | . . . | . . . | . . . | 0.2 | 0.7 | 1 |

The antecedent part of the rule encoding for each attribute consist of three bits, of which two are continuous bits and one is a discrete bit. So, a PSO with mixed encoding for continuous as well as discrete bits is used for 3*A+N values.

According to one embodiment herein, the first two bits lies between [0,1]. When the value of second bit is greater than 0.5 then corresponding attribute value is considered less than the benchmark. When the value of second bit is equal to or less than 0.5 then corresponding attribute value is more than or equals to the benchmark. The value of the third bit will be either 0 or 1. When the third bit is 1 then that attribute is included in the rule or else not.

TABLE 4
Consequent part of the rule expanded

| | | | | |
|---|---|---|---|---|
| Predicted | Predicted | Predicted target | • • • | Predicted target |
| target | target | value of 3^{rd} sample | | value of N^{th} sample |
| value of | value of | | | |
| 1^{st} sample | 2^{nd} sample | | | |

According to one embodiment herein, the consequent part of the rule is of length N. Each of the N bits is configured to hold the predicted values of the target for each sample in the training dataset. Out of N bits, PSO is configured to generate predicted target values for only those samples which are covered by a preset rule so that the samples strictly follow the antecedent part of the rule. Rest of the bits remains constant and has zero (no/nil) contribution in the generation of Prediction Interval.

According to one embodiment herein, quantile regression is used to control the division of samples into deciles and sequential calling of PSO for the training dataset. Each rule has one antecedent part and one consequent part. For objective function-1, the antecedent part of the rule is used to determine the coverage, so that the samples strictly satisfying the antecedent part are determined. Further, the consequent part of the rule to achieve the predicted target values for these samples are computed. Consequently, the Pearson correlation coefficient between the attributes and the predicted target values of the samples in the coverage is computed. Thereafter, the Pearson correlation coefficient between the attributes and the actual target values for the entire dataset is computed. Finally, the attribute wise difference between these two correlation vectors are determined/computed. When the computed difference is less than the threshold, then the SUM is incremented by 1 (Initially SUM is equal to 0).

According to one embodiment herein, a plurality of algorithms are provided respectively for quantile regression, PSO rule miner, computation of first objective function, computation of second objective function, computation of PI, and ensembling processes.

According to one embodiment herein, a prediction interval is associated with each rule/particle. Every rule has a coverage C consisting of c points. Using consequent part of the rule, the predicted values are extracted. To prevent uncertainties, Prediction Intervals are determined. For each rule, a PI is predicted. Further, a vector consisting of predicted target variable of all the samples covered by a rule is generated using an antecedent part. The mean and the standard deviation of all the elements in the vector are computed. Further, an interval (PI) within which the output values of all the samples covered by a rule lies is determined. The interval is [(μ−σ), (μ+σ)], where μ is the computed mean of the elements of the vector and σ is the computed standard deviation of the elements of the vector. Thus, for each rule R, an interval of [(μ−σ), (μ+σ)] for the target/output variable of all the samples in test/train set, covered by the rule R is determined. So, the width of the proposed interval is chosen as 2*σ because it is small but at the same time it is large enough to have a high number of correct predictions. The sequence of steps involved in computation is as follows:
1. For each rule R, the coverage C of the rule R is computed, so that a set consisting of samples in the train set satisfies the antecedent part of rule R.
2. The predicted target values Yᵢ* for each sample present in the set C are extracted using the consequent part of rule.
3. Mean (μ) and standard deviation (σ) of all the extracted predicted target value Yᵢ* are computed.
4. An interval for target/output variable of the samples covered by the rule as [(μ−σ), (μ+σ)] is computed.

According to an embodiment herein, the system and method are provided to generate/develop a Particle Swarm Optimization and Quantile Regression based Rule Miner with Prediction intervals for Regression tasks. Initially, the samples/data set are divided into deciles and a sequential covering of PSO for the training dataset is performed. According to an embodiment herein, two models (first and second models) are generated respectively with a mutually different objective functions required to judge/estimate the fitness of each particle. The first objective function associated with the first model (Model-1) is configured to depend on the Pearson correlation coefficient. The second objective function associated with the second model (Model-2) is configured to depend on a Mean Squared Error (MSE) of the predicted target variables along with the Pearson correlation coefficient.

According to an embodiment herein, a method and system for Pearson correlation coefficient-based prediction of the target variable with the help of particle swarm optimization is disclosed. Thus, the system provides an approach to compute prediction interval without compromising the accuracy. The present invention discloses an intuitive method of constructing prediction intervals. The system discloses an architecture for determining a final output of PSO based quantile regression rule miner for finding the Prediction Intervals (PI). Further, the system generates ‘if-then’ rules that yield prediction intervals while solving a multivariate regression problem. The system provides ensembling based on the metrics of prediction intervals reduces the rule base to a manageable number.

According to the present invention, the data is divided into deciles based on decreasing order of target attribute and for each decile, PSO is implemented to derive a set of rules and capture the heteroscedasticity of the distribution of the data from quantile regression.

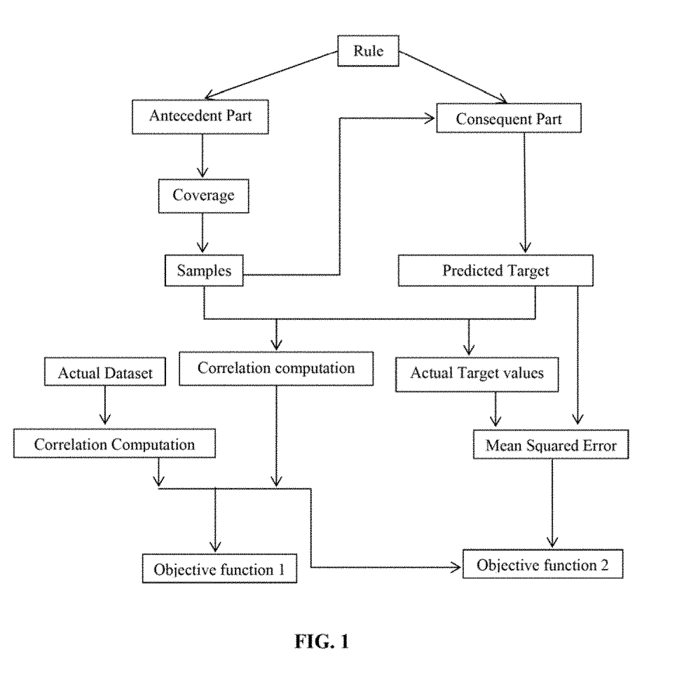

FIG. 1 illustrates a flowchart explaining a method for computing the two objective functions in a method for generating Particle Swarm Optimization and Quantile Regression based Rule Miner with Prediction intervals for Regression problems, according to one embodiment herein.

Initially, the division of samples into deciles and sequential calling of PSO for the training dataset. In accordance with the invention, the objective function 1 depends on the Pearson correlation coefficient. The objective function 2 of the second model (Model-2) depends on computing Mean Squared Error (MSE) of the predicted target variables along with the Pearson correlation coefficient.

According to the present invention, Rule Encoding such as Michigan approach is utilized for training the samples present in the decile. The rule encoding is of length (3*A+N), where A is the number of attributes, and N represents the number of samples present in the training decile is displayed in table given below.

TABLE 1
Rule Encoding

| | |
|---|---|
| Antecedent Part ((3*A) bits) | Consequent Part (N bits) |

According to one embodiment herein, the antecedent part is of length 3*A. For each attribute, 3 bits are provided. The first bit is a continuous value representing the benchmark value of the given attribute. The second bit indicates whether the respective attribute's value is greater than or equal to or less than the first bit value/benchmark. The third bit, decides whether the attribute is included in the rule or not.

TABLE 2
Rule Encoding for the Antecedent

| | | |
|---|---|---|
| Benchmark | ≥ or < | 0 or 1 |

TABLE 3
Antecedent part of the rule expanded

| Dimension 1 | | | Dimension 2 | | | Dimension 3 | | | - - - | | | Dimension A | | |
|---|---|---|---|---|---|---|---|---|---|---|---|---|---|---|
| 0.5 | 0.7 | 1 | 0.3 | 0.4 | 0 | 0.7 | 0.9 | 1 | . . . | . . . | . . . | 0.2 | 0.7 | 1 |

The antecedent part of the rule encoding for each attribute consist of three bits, of which two are continuous bits and one is a discrete bit. So, a PSO with mixed encoding for continuous as well as discrete bits is used for 3*A+N values.

According to one embodiment herein, the first two bits lies between [0,1]. When the value of second bit is greater than 0.5 then corresponding attribute value is considered less than the benchmark. When the value of second bit is equal to or less than 0.5 then corresponding attribute value is more than or equals to the benchmark. The value of the third bit will be either 0 or 1. When the third bit is 1 then that attribute is included in the rule or else not.

TABLE 3
Consequent part of the rule expanded

| | | | | |
|---|---|---|---|---|
| Predicted | Predicted | Predicted target | • • • | Predicted target |
| target | target | value of 3^{rd} sample | | value of N^{th} sample |
| value of | value of | | | |
| 1^{st} sample | 2^{nd} sample | | | |

However, the consequent part of the rule is of length N. Each of the N bits holds the predicted values of the target for each sample in the training dataset. Out of N bits, PSO will generate predicted target values for only those samples which are covered by that rule i.e. the samples which strictly follows the antecedent part of the rule. Rest of the bits will remain constant and will have zero contribution in the generation of Prediction Interval.

According to the present invention, quantile regression is used to control the division of samples into deciles and sequential calling of PSO for the training dataset (‘d’ is the decile index of ten deciles and ‘p’ is the index of the particle in the population ‘P’). The procedure is listed as follows:
1. Sort the train set in decreasing order of output variable.
2. Divide the sorted data into 10 equal deciles each having Ni number of samples.
3. Initialize 10 rule bases, each as a void set.
4. For each decile ‘d’ in train set
5. Until all samples in the decile are covered.
6. Generate rule Rₚ covering Cₚ samples of the decile using PSO rule miner as given below.
7. Add rule Rₚ to the i^{th} rule base.
9. Declare Cₚ samples as covered and exclude them from the decile.
8. Repeat step 6 for remaining uncovered samples.
9. End Until
10. End For
11. Return the union of 10 rule bases.

With respect to FIG. 1, each rule has one antecedent part and one consequent part. For objective function-1, the antecedent part of the rule is used to determine the coverage, i.e. the samples strictly satisfying the antecedent part are determined. Further, the consequent part of the rule to achieve the predicted target values for these samples are computed. Consequently, the Pearson correlation coefficient between the attributes and the predicted target values of the samples in the coverage is computed. Thereafter, the computation of Pearson correlation coefficient between the attributes and the actual target values for the entire dataset. Finally, the attribute wise difference between these two correlation vectors and if this difference is less than the threshold then we increase the SUM by 1 (Initially SUM is 0).

To compute fitness of a rule R (Objective function 1) for a train set, the steps are as following:
1. Compute the coverage C of the rule R, i.e. a set consisting of samples in the train set satisfying antecedent part of rule R.
2. Extract the predicted target values Y* for each sample ‘m’ present in the set C using the consequent part of Rule.
3. Compute the Pearson Correlation Coefficient for each attribute Aⱼ with the actual target variable Y for all samples in the set C, and store them in a vector P, i.e. [p₁,p₂, . . . ,pₖ], where j=1, 2, . . . , k and ‘k’ is a total number of attributes a sample has.
4. Compute the Pearson Correlation Coefficient for each attribute Aⱼ with the predicted target variable Y* for all samples in the set C, and store them in a vector P*, i.e. [p₁*,p₂*, . . . pₖ*], where j=1, 2, . . . , k and ‘k’ is total number of attributes a sample has. Let ‘c’ number of samples is present in set C then,

P=[COR(A₁,Y),COR(A₂,Y), . . . ,COR(Aₐ,Y)]

P*=[COR(A₁,Y*),COR(A₂,Y*) . . . ,COR(Aₐ,Y*)],
where, Y* is a vector consisting of predicted value of target variable for all the samples in the set C in a sample-wise ordered fashion, Y is a vector consisting of the actual value of target variable for all the samples in the set C in a sample-wise ordered fashion.
5. Compute the quantities SUM in the following manner.
Loop from j=1 to k
IF (|Pⱼ−Pⱼ*|<=Threshold)
Then SUM=SUM+1 where j=1, 2, . . . , k
6. Compute Fitness as Fitness=SUM.

In order to determine the second objective function, the aforementioned procedure is repeated to compute the two correlation vectors. Further, Mean Squared Error (MSE) is computed between predicted target values and the actual target values for all the samples which follow the antecedent part of the rule. Thereafter, MSE and SUM is generated, the function returns a value of ((SUM/k)−MSE), where ‘k’ is the number of attributes. The steps to compute fitness of a rule R for a train set, are as follows:
1. Compute the coverage C of the rule R, i.e. a set consisting of samples in the train set satisfying antecedent part of rule R.
2. Extract the predicted target values Y* for each sample ‘m’ present in the set C using the consequent part of Rule.
3. Compute the Pearson Correlation Coefficient for each attribute Aⱼ with the actual target variable Y for all samples in the set C, and store them in a vector P, i.e. [p₁, p₂, . . . , pₖ], where j=1, 2, . . . , k and ‘k’ is a total number of attributes a sample has.
4. Compute the Pearson Correlation Coefficient for each attribute Aⱼ with the predicted target variable Y* for all samples in the set C, and store them in a vector P*, i.e. [p₁*, p₂*, . . . , pₖ*], where j=1, 2, . . . , k and ‘k’ is total number of attributes a sample has. If ‘c’ number of samples is present in set C then,

P=[COR(A₁,Y),COR(A₂,Y), . . . ,COR(Aₖ,Y)]

P*=[COR(A₁,Y*),COR(A₂,Y*) . . . ,COR(Aₖ,Y*)],
where, Y* is a vector consisting of predicted value of target variable for all the samples in the set C in a sample-wise ordered fashion,
Y is a vector consisting of the actual value of target variable for all the samples in the set C in a sample-wise ordered fashion.
5. Compute the quantities SUM and MSE in the following manner.
SUM=0
Loop from j=1 to k
IF (|Pⱼ−Pⱼ*|<=Threshold)
Then SUM=SUM+1 where j=1, 2, . . . , k
MSE=0
Loop from m=1 to c

MSE=(Σ((YₘY−ₘ*)²))/c where m=1,2, . . . ,c
6. Compute Fitness as
Fitness=((SUM/k)−MSE).

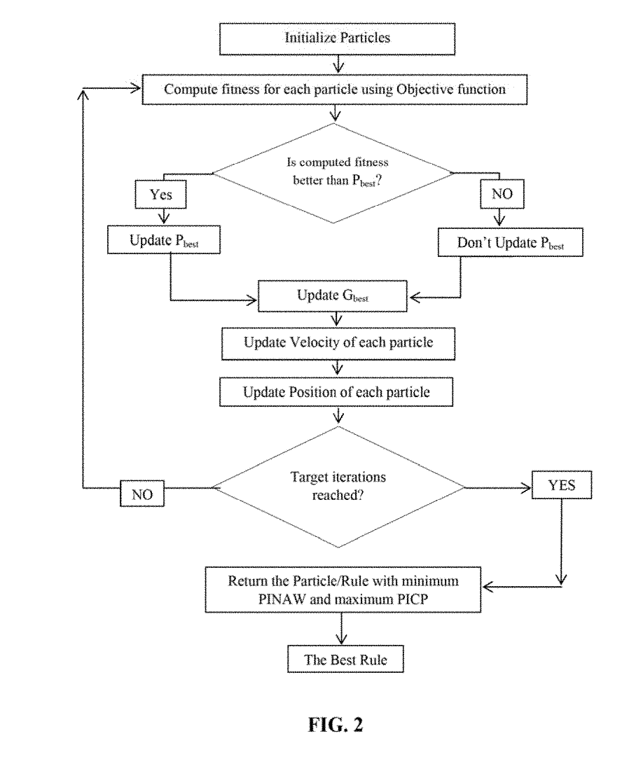

FIG. 2 is a flowchart explaining a method for finding the best rule using one of the two objective functions with the help of Particle Swarm Optimization, Quantile Regression and Prediction intervals for Regression problems, according to one embodiment herein.

According to the present invention, the method for determing the best rule is as follows:

1. Initialize P (particles/rules)*L (Length of Rule encoding) in range [0,1]
2. Initialize velocity V of particle in range [−1,1].
3. Initialize P_{ibest} (Personal best state for a particle) as particle

P_{ibest}=Xᵢ

4. Initialize G_{best} with X_{g}, where X_{g} is the particle with the least fitness in the population.
5. For each iteration k, for each particle i in the population
6. Randomly generate r₁ and r₂ from random uniform distribution [0,1].
7. Update particle's velocity(Vᵢ) and position(Xᵢ) as

Vᵢ^{k+1}<−w*Vᵢ^{k}+c₁*r₁*(P_{best}−Xᵢ^{k})+c₂*r₂*(G_{best}−Xᵢ^{k})

Xᵢ^{k+1}<−Xᵢ^{k}+Vᵢ^{k+1},

where Vᵢ^{k} is the velocity of i^{th} particle in k^{th} iteration,
Xᵢ^{k} is position of i^{th} particle in the k^{th} iteration,
And w is the inertial weight.
8. Compute fitness using the objective function.
9. Compute Prediction Interval for the samples covered by the Particle/Rule.
10. Update swarms personal best and global best

P_{ibest}=Xᵢ if F(P_{ibest})<F(Xᵢ)

G_{best}=Xᵢ if F(G_{best})<F(Xᵢ) where F is our objective function.

### 11. End For

### 12. End For

13. Compute PICP, PINAW for selecting the best particle in the population.

PICP=P/Q, where 0<=PICP<=1

Where P is a total number of cases in which actual output value for a sample covered by a rule lies between the predicted intervals.
Q is a total number of samples covered by a rule.

$$PINAW = \frac{1}{NR} {\sum }_{t = 1}^{N} ( {L}_{t} - {U}_{t} )$$

Where Ui and Li represents the upper bound and lower bound of a predicted interval, and N is a total number of samples for which prediction is being done, and R is the range of actual output variable values of all the samples in the coverage.
14. Finally, the rule with maximum PICP and minimum PINAW is reported.

According to the present invention, a prediction interval is associated with each rule/particle. Every rule has a coverage C consisting of c points. Using consequent part of the rule, the predicted values are extracted. To prevent uncertainties, Prediction Intervals are determined. For each rule, an interval is predicted. Further, a vector is generated consisting of predicted target variable for all the samples covered by a rule using its antecedent part. The mean and the standard deviation of all the elements in the vector is computed. Further, an interval in which the output values of all the samples covered by a rule lies is determined. The interval is [(μ−σ), (μ+σ)], where μ is the computed mean of the elements of the vector and a is the computed standard deviation of the elements of the vector. Thus, for each rule R, an interval of [(μ−σ), (μ+σ)] for the target/output variable of all the samples in test/train set, covered by the rule R is determined. So, the width of the proposed interval is chosen as 2*σ because it is small at the same time large enough to have a high number of correct predictions. The sequence of steps involved in computation is as follows:
1. For each rule R, the coverage C of the rule R is computed, i.e. a set consisting of samples in the train set satisfying antecedent part of rule R.
2. Extract the predicted target values Yᵢ* for each sample present in the set C using the consequent part of rule.
3. Compute mean (μ) and standard deviation (σ) of all the extracted predicted target value Yᵢ*.
4. Propose the interval for target/output variable of the samples covered by the rule as [(μ−σ), (μ+σ)].

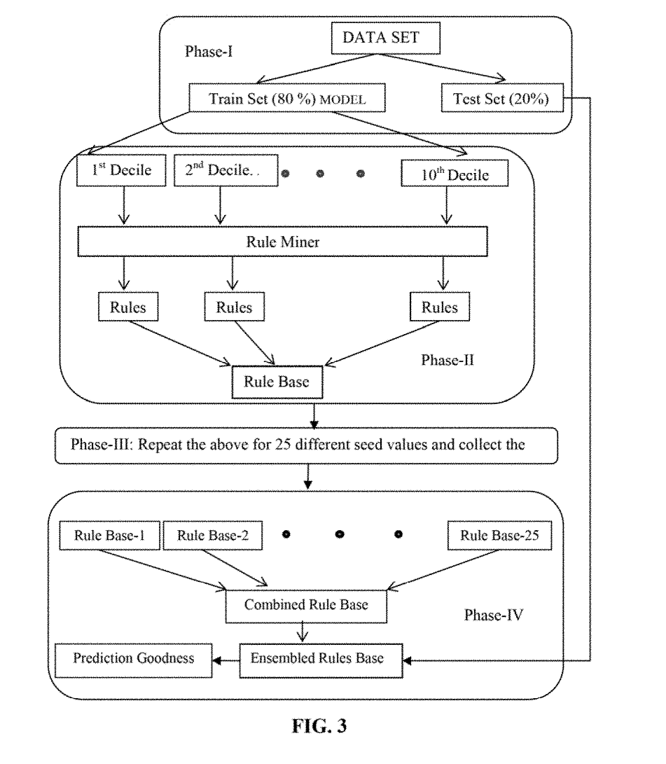

FIG. 3 illustrates a functional block diagram of a system for generating Particle Swarm Optimization and Quantile Regression based Rule Miner with Prediction intervals for Regression problems using ensembling principle, according to one embodiment herein.

According to the present invention, the process of rule mining is applied around 25 times and thereafter all the rules bases are ensembled. Subsequently, a set of rules are selected from the ensemble rule bases. The steps of selecting a set of rules are as follows:

a) Execute the Rule Miner for 25 runs and collect 25 Rule bases.

b) Merge all the 25 Rule base and form a rule base RB-I. Round-off the 1^{st} and 2^{nd} values in a rule, viz., the benchmark and the relational sign (≥ or <) up to two decimal places. Further, remove the repeated rules, if any.

c) Sort RB-I on the basis of prediction interval width in the ascending order.

d) Traverse entire sorted rule base. If for at least one of the covered samples the actual target value lies within the Prediction interval generated by the rule, then the rule in rule base RB-II (Rule-base of Ensembled rules) are collected and the samples are removed. Repeat the process until no sample is left in the training set.

e) Remove all the rules in RB-II with coverage less than 1% of a total number of samples in the entire dataset to form RB-III. RB-III is the final database of Ensembled rules with threshold of 1% on coverage.

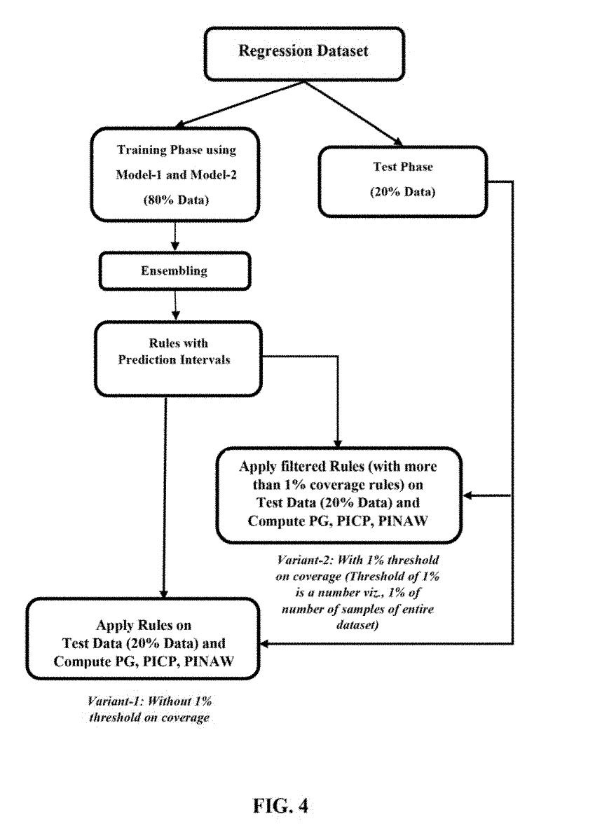

FIG. 4 is flowchart illustrating the method involved in determining rules and prediction intervals in two variants with a given model. The method includes receiving, by the computing device, the historical data set including a plurality of input variables and a single output variable. Further, the received data is segregated by the computing device into a training data set of ten deciles and a test data. Subsequently, a set of rules, a first objective function for the training data are determined by the computing device. The objective function is configured to judge a fitness of each data item in the data input, and wherein the set of rules are stored in a rule base. A particle swarm optimization based quantile regression is executed for a predefined number of times to generate a set of rule bases. The set of rule bases are stored in a combined rule base. The set of rules with a threshold greater than one percent on coverage are ensembled from a combined rule base. Thereafter, the prediction intervals associated with the data set using the rule are estimated.

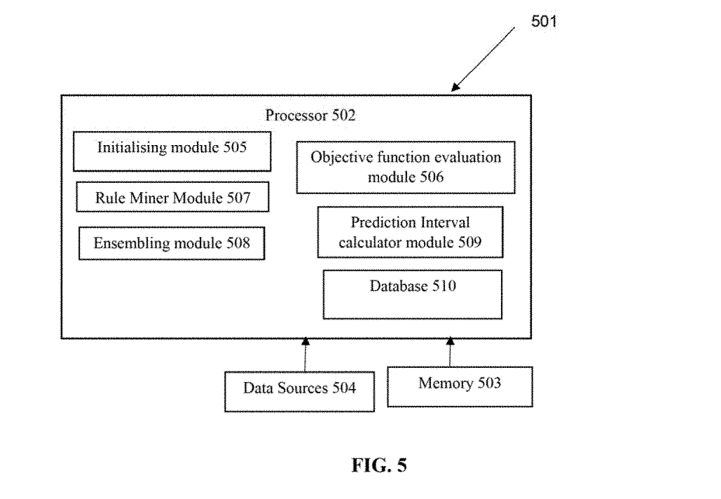

FIG. 5 illustrates a computing device/system for implementing a particle swarm optimization (PSO) based regression model in a computing environment. The system/computing device 501 comprises a hardware processor 502 coupled to a memory 503 containing instructions configured for estimating prediction intervals of each rule covering samples in the data set, wherein the hardware processor 502 is configured to receive the historical data set including a plurality of input variables and a single output variable from data sources 504. The computing device includes an initializing module 505 configured to segregate the data set into a training data set of ten deciles and a test data. The computing device includes an objective function evaluation module 506 to determine a first objective function for the training data, and wherein the objective function is configured to judge a fitness of each data item in the data input. The computing device includes a rule miner module 507 configured to determine a set of rules for encoding, and wherein the set of rules are stored in a rule base. The rule miner module 507 is configured to execute a particle swarm optimization-based quantile regression on the dataset for a predefined number of times to generate a set of rule bases. The computing device includes a prediction interval calculator module 509 configured to estimate prediction intervals associated for each of the rule, covering samples of the dataset. The set of rule bases are stored in a database as combined rule base. The computing device includes an ensembling module 508 to ensemble the set of rules from the combined rule base with a threshold of one percent on coverage from a combined rule base.

According to an embodiment herein, the rule miner module 507 is further configured to generate a rule Rₚ covering Cₚ samples of the training dataset decile using PSO rule miner; and add each rule Rₚ to the rule base.

According to an embodiment herein, the objective function evaluation module 506 is configured to analyze the results of the two generated models using a set of performance measures. The set of performance measures includes Prediction Goodness, PINAW, PICP, and other metrics like number of rules generated as well as average rule length for each model. The first objective function is configured to generate less number of rules having high PG, high and consistent PICP and very less PINAW. The second objective function is configured to generate rules with slightly less PG, low PICP, and more PINAW than the first objective function. A threshold is applied on over fitting rules to improve the results thereby decreasing the number of rules and PINAW without much change in prediction goodness and PICP.

According to an embodiment herein, the objective function evaluation module 506 is configured to determining the first objective function comprising of selecting an antecedent part of the rule to determine coverage; selecting a consequent part of the rule to determine predicted target values for samples covered by the rule in each decile of the dataset; compute a first Pearson correlation coefficient for each attribute with a predicted target variable for samples covered by the rule in each decile of the dataset; compute a second Pearson correlation coefficient for each attribute with an actual target variable for samples covered by the rule in each decile; determine a total number of times the difference between the first Pearson correlation coefficient and the second Pearson correlation coefficient becomes less than a pre-specified threshold; and determine the fitness, where fitness equal to SUM value.

According to an embodiment herein, the objective function evaluation module 506 is configured to determining a second objective function comprising of selecting an antecedent part of the rule to determine coverage; selecting a consequent part of the rule to determine predicted target values for samples covered by the rule in each decile of the dataset; computing a first Pearson correlation coefficient for each attribute with a predicted target variable for samples covered by the rule in each decile of the dataset; computing a second Pearson correlation coefficient for each attribute with an actual target variable for samples covered by the rule in each decile of the dataset; determining a total number of times the difference between the first Pearson correlation coefficient and the second Pearson correlation coefficient becomes less than a pre-specified threshold; computing a Mean Squared Error (MSE) between the predicted target values and the actual target values for all samples, wherein the samples belong to the antecedent part of the rule; and determining a fitness as a difference between the normalized sum and the mean square error.

According to an embodiment herein, the rule miner module 507 is further configured to initialise particles, wherein a best state for a particle is initialized as P_{best} and a particle with highest fitness in the population is initialized as G_{best}; compute a fitness function for each particle using at least one of the first objective function and the second objective function; determine whether the computed fitness for each particle is better than the best state of particle P_{best}; update the best state of particle P_{best} when the computed fitness is better than initial P_{best}; update velocity and position of each particle; determine the particle with minimum Prediction Interval Normalized Average Width (PINAW) and maximum (Prediction Interval Coverage Probability) PICP for selecting the best particle in the population; and determine the best rule based on PINAW and PICP values.

According to an embodiment herein, the prediction interval calculator module 509 is further configured to compute the coverage of each rule in the rule base, wherein the coverage is determined by selecting the part of the train data set that follows the antecedent part of rule; determine predicted target values Yᵢ* for each sample present in the set using the consequent part of rule; compute mean (μ) and standard deviation (σ) of all the extracted predicted target value; and estimate a prediction for output variable of the samples covered by the rule as [(μ−σ), (μ+σ)].

According to an embodiment herein, the ensembling module is further configured to eliminate the rules in the rule base with coverage less than one percent of a total number of samples in the entire dataset to form the ensembled rules.

According to an embodiment herein, the database 510 stores a set of rules, combined rule base, and ensembled rules.

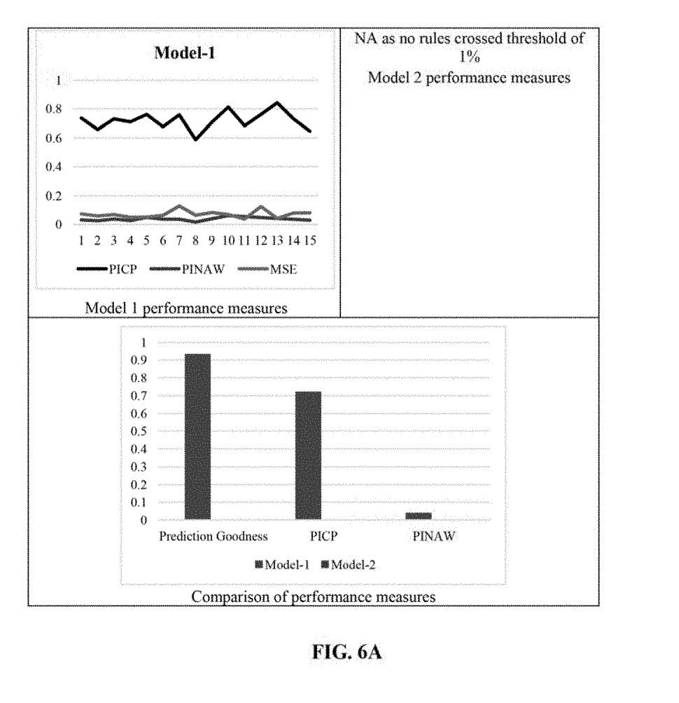

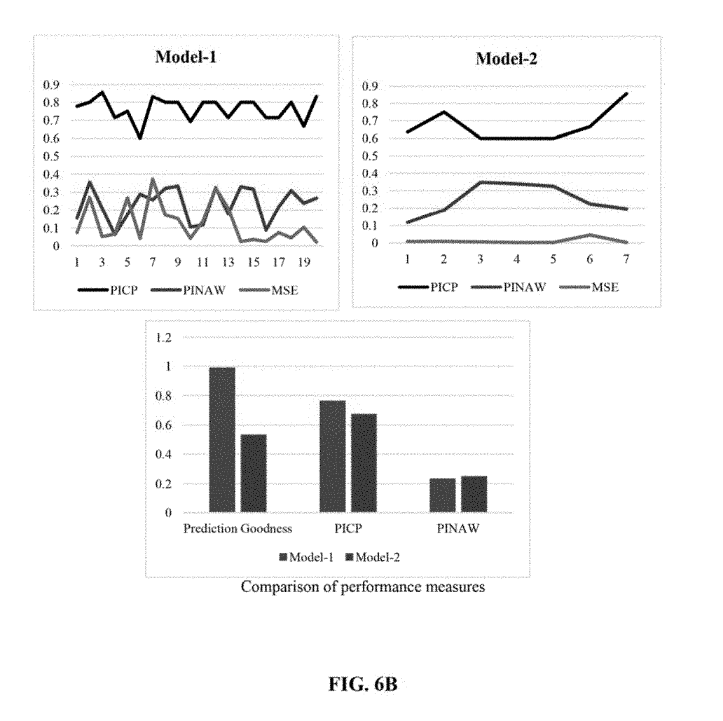

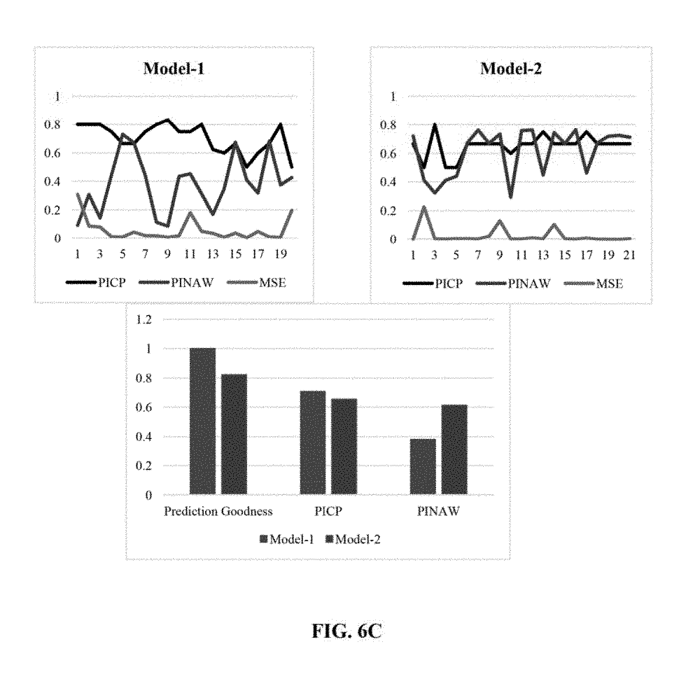

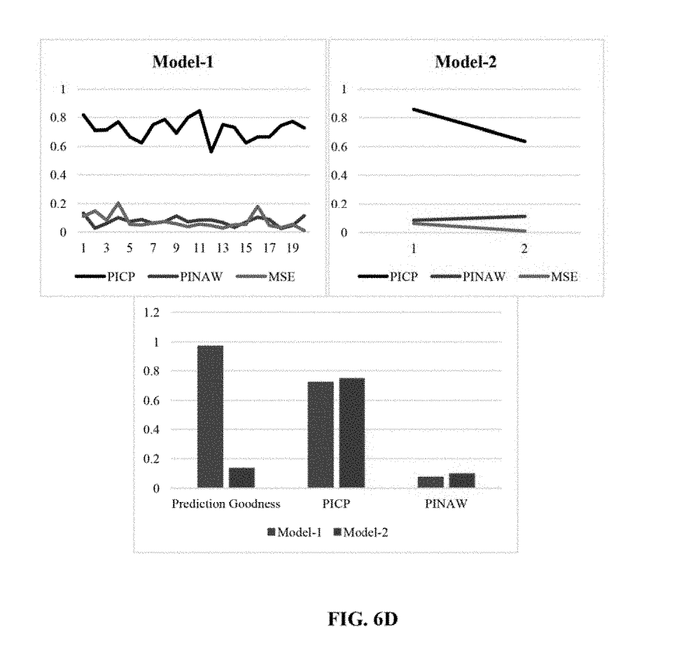

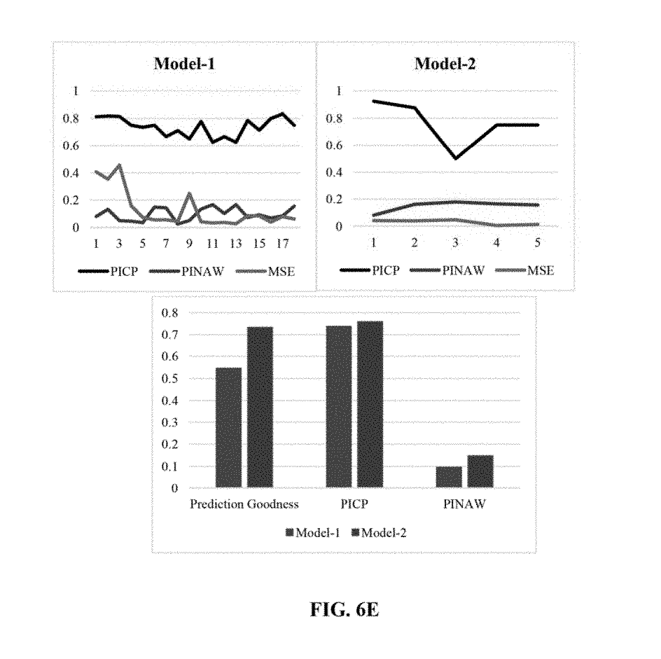

FIG. 6A illustrates a chart indicating a comparison of performance measures of two models used in a method for generating Particle Swarm Optimization and Quantile Regression based Rule Miner with Prediction intervals for Regression problems, according to one embodiment herein.

According to the present invention, an objective function is applied on each dataset for 25 times (Model-1 and Model-2). Later, for each dataset, rule bases (for example, 25 rule bases) are combined for each objective function separately. Finally, a set of rules is obtained from the combined rule base and ensembled rules are obtained as described in FIG. 3 and FIG. 4. Further, the rules so obtained are applied on the test set. Subsequently, all the rules in the final ensembled rule set having coverage less than 1% of total samples present in the entire dataset are filtered out. The new rule set is proposed as ensembled rules (1% threshold on coverage). Thus, two sets of ensembled rules are derived for each model including ensembled rules with and without a threshold of 1% on coverage. The process of determining PICP and PINAW is applied for all the five datasets displayed in Table 4.

TABLE 4

| | | Number of instances | | | Number | |
|---|---|---|---|---|---|---|
| | | | Train | Test | of | Target |
| # | Dataset | Dataset | (80%) | (20%) | attributes | Variable |
| 1. | Abalone | 1528 | 1222 | 306 | 7 | Rings |
| 2 | Bike Rental | 414 | 331 | 83 | 5 | Demand |
| 3. | Body fat | 252 | 201 | 51 | 14 | Bodyfat |
| 4. | Concrete | 1030 | 824 | 206 | 9 | Concrete |
| | | | | | | compressive |
| | | | | | | strength |
| 5.a | Energy | 768 | 614 | 154 | 8 | Heating |
| | efficiency | | | | | load |
| 5.b | | | | | 8 | Cooling |
| | | | | | | load |

The results for Prediction Interval Coverage Probability (PICP) and PINAW and performance for data ‘Abalone’ is illustrated in FIG. 6A.

With respect to FIG. 6A, Model-1 displays a better Prediction goodness as compared to Model-2. In the present example, Model-2 generates very specific rules and 100% of the rules generated by Model-2 has coverage less than 1% of the total number of samples in the dataset. Thus, when rules are filtered, most of the rules are discarded, and the final rule base does not represent a train data set for Model-2. Hence Model-1 performed well with respect to Prediction Goodness, and the rules were consistent regarding PINAW and PICP.

After generating 25 rule bases from 25 executions, all the rule bases are combined and a set of rules which explains the entire train set is selected. The set of rules is called the ensembled rules. Later, rules with low coverage are filtered, with a threshold value on the rule. The rule with coverage of more than 1% of a total number of samples in the entire dataset is picked up as ensembled rules.

A threshold of 1% provided decreased number of rules, decreased Prediction Goodness, decreased PICP and decreased PINAW. Thus, improved generalized rules are obtained by reducing PINAW, PICP and Prediction Goodness.

FIG. 6A illustrates a chart indicating a comparison of performance measures of two models used in a method for generating Particle Swarm Optimization and Quantile Regression based Rule Miner with Prediction intervals for Regression problems, according to one embodiment herein.

FIG. 6B illustrates a chart indicating a comparison of performance measures of two models used in a method for generating Particle Swarm Optimization and Quantile Regression based Rule Miner with Prediction intervals for Regression problems in another exemplary embodiment.

FIG. 6C illustrates a chart indicating a comparison of Prediction Goodness, PICP and PINAW for two models with 1% threshold on coverage in an exemplary embodiment.

FIG. 6D illustrates a chart indicating a comparison of Prediction Goodness, PICP and PINAW for two models with 1% threshold on coverage in an exemplary embodiment.

FIG. 6E illustrates a chart indicating a comparison of Prediction Goodness, PICP and PINAW for two models with 1% threshold on coverage in an exemplary embodiment.

Advantageously, the present invention provides a system and method for Pearson correlation coefficient-based prediction of the target variable with the help of Particle swarm optimization. Thus, the system provides an approach to compute prediction interval without compromising the accuracy. The present invention discloses an intuitive method of constructing prediction intervals. The system discloses an architecture for determining a final output of PSO based quantile regression rule miner for finding the Prediction Intervals (PI). Further, the system generates ‘if-then’ rules that yield prediction intervals while solving a multivariate regression problem. The system provides ensembling based on the metrics of prediction intervals, thereby reducing the rule base to a manageable number.

The present method of constructing prediction intervals is intuitive and straightforward than the traditional methods of finding PIs. Even the fitting of quantile regression is intuitive, human comprehensible and easier compared to the conventional way of fitting the same. The final output of PSO based quantile regression rule miner for finding the Prediction Intervals is the novel hybrid architecture.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer-implemented method of a particle swarm optimization (PSO) based regression model for estimating prediction intervals of a data set, by a computing device, the method comprising:
receiving, by the computing device, historical data set including a plurality of input variables and a single output variable;
segregating, by the computing device, the data set into a training data set of ten deciles and a test data;
determining by the computing device, a set of rules for encoding, a first objective function for the training data, and wherein the objective function is configured to judge a fitness of each data item in the data input, and wherein the set of rules are stored in a rule base;
executing a particle swarm optimization based quantile regression for a predefined number of times to generate a set of rule bases, wherein the set of rule bases is stored in a combined rule base;
ensembling the set of rules from the combined rule base with a threshold of one percent on coverage from a combined rule base, by the computing device; and
estimating by the computing device, prediction intervals associated with the data set using the rule.

2. The method as claimed in claim 1, wherein the step of generating the set of rules comprises:
generating a rule Rₚ covering Cₚ samples of the training dataset decile using PSO rule miner; and
adding each rule Rₚ to the rule base.

3. The method as claimed in claim 1, wherein the step of determining a first objective function comprises:
selecting an antecedent part of the rule to determine coverage;
selecting a consequent part of the rule to determine predicted target values for samples covered by the rule in each decile of the dataset;
computing a first Pearson correlation coefficient for each attribute with a predicted target variable for samples covered by the rule in each decile of the dataset;
computing a second Pearson correlation coefficient for each attribute with an actual target variable for samples covered by the rule in each decile of the dataset;
determining a sum value as a total number of times the difference between the first Pearson correlation coefficient and the second Pearson correlation coefficient provides a value less than a pre-specified threshold; and
determining a fitness of each particle, where fitness is equal to the sum value.

4. The method as claimed in claim 1, wherein the step of determining a second objective function comprises:
selecting an antecedent part of the rule to determine coverage;
selecting a consequent part of the rule to determine predicted target values for samples covered by the rule in each decile of the dataset;
computing a first pearson correlation coefficient for each attribute with a predicted target variable for samples covered by the rule in each decile of the dataset;
computing a second pearson correlation coefficient for each attribute with an actual target variable for samples covered by the rule in each decile of the dataset;
determining a sum value as a total number of times the difference between the first Pearson correlation coefficient and the second Pearson correlation coefficient provides a value less than a pre-specified threshold;
computing a Mean Squared Error (MSE) between the predicted target values and the actual target values for all samples, wherein the samples belong to the antecedent part of the rule;
determining a fitness as a difference between the normalized sum value and the mean square error.

5. The method as claimed in claim 1, wherein the step of executing a particle swarm optimization-based rule miner for a predefined number of times comprises:
initializing particles present in the dataset, wherein a best state for a particle is initialized as P_{best} and a particle with highest fitness in the population is initialized as G_{best};
computing a fitness function for each particle using at least one of the first objective function and the second objective function;
determining whether the computed fitness for each particle is better than the best state of particle P_{best};
updating the best state of particle P_{best} when the computed fitness is better than initial P_{best};
updating velocity and position of each particle;
determining the particle with minimum Prediction Interval Normalized Average Width (PINAW) and maximum (Prediction interval Coverage Probability) PICP for selecting the best particle in the population; and
determining the best rule based on PINAW and PICP values.

6. The method as claimed in claim 1, wherein the step of estimating prediction intervals further comprises:
computing the coverage of each rule in the rule base, wherein the coverage is determined by selecting the part of the train data set that follows the antecedent part of rule;
determining the predicted target values Yᵢ* for each sample present in the set using the consequent part of rule;
computing mean (μ) and standard deviation (σ) of all the extracted predicted target value; and
estimating a prediction for output variable of the samples covered by the rule as [(μ−σ), (μ+σ)].

7. The method as claimed in claim 1, wherein the step of ensembling the set of rules further comprises:
eliminating the rules in the rule base with coverage less than one percent of a total number of samples in the entire dataset to form the ensembled rules.

8. A computing device for a particle swarm optimization (PSO) based regression model in a computing environment, the system comprising:
a hardware processor coupled to a memory containing instructions configured for estimating prediction intervals of a data set, wherein the hardware processor is configured to receive the historical data set including a plurality of input variables and a single output variable;
an initializing module configured to segregate the data set into a training data set of ten deciles and a test data;
an objective function evaluation module configured to determine a first objective function for the training data, and wherein the objective function is configured to judge a fitness of each data item in the data input;
a rule miner module configured to determine a set of rules for encoding, and wherein the set of rules are stored in a rule base, wherein the rule miner module is configured to execute a particle swarm optimization-based quantile regression on the dataset for a predefined number of times to generate a set of rule bases, wherein the set of rule bases are stored in a database as combined rule base;
an ensembling module configured to ensemble the set of rules from the combined rule base with a threshold of one percent on coverage from a combined rule base; and
a prediction interval calculator module configured to estimate prediction intervals associated with the data set using the rule.

9. The computing device as claimed in claim 1, wherein the rule miner module is further configured to generate a rule Rₚ covering Cₚ samples of the training dataset decile using PSO rule miner, and add each rule Rₚ to the rule base.

10. The computing device as claimed in claim 1, wherein the objective function evaluation module is configured to:
select an antecedent part of the rule to determine coverage;
select a consequent part of the rule to determine predicted target values for samples in the dataset covered by the rule;
compute a first Pearson correlation coefficient for each attribute with a predicted target variable for samples covered by the rule in each decile of the dataset;
compute a second Pearson correlation coefficient for each attribute with an actual target variable for samples covered by the rule in each decile of the dataset;
determine a total number of times the difference between the first Pearson correlation coefficient and the second Pearson correlation coefficient becomes less than a pre-specified threshold;
determine a sum value as difference between the first Pearson correlation coefficient and the second Pearson correlation coefficient less than fixed pre-specified threshold; and
determine a fitness of each particle, where the fitness is equal to the sum value.

11. The computing device as claimed in claim 1, wherein the objective function evaluation module is configured to:
select an antecedent part of the rule to determine coverage;
select a consequent part of the rule to determine predicted target values for samples in the dataset covered by the rule;
compute a first Pearson correlation coefficient for each attribute with a predicted target variable for samples covered by the rule in each decile of the dataset;
compute a second Pearson correlation coefficient for each attribute with an actual target variable for samples covered by the rule in each decile of the dataset;
determine a sum value as the total number of times the difference between the first Pearson correlation coefficient and the second Pearson correlation coefficient becomes less than a pre-specified threshold;
compute a Mean Squared Error (MSE) between the predicted target values and the actual target values for all samples, wherein the samples belong to the antecedent part of the rule; and
determine a fitness as a difference between the normalized sum value and the mean square error.

12. The computing device as claimed in claim 1, wherein the rule miner module is further configured to:
initialise particles present in the dataset, wherein a best state for a particle is initialized as P_{best} and a particle with highest fitness in the population is initialized as G_{best};
compute a fitness function for each particle using at least one of the first objective function and the second objective function;
determine whether the computed fitness for each particle is better than the best state of particle P_{best};
update the best state of particle P_{best} when the computed fitness is better than initial P_{best};
update velocity and position of each particle;
determine the particle with minimum Prediction Interval Normalized Average Width (PINAW) and maximum (Prediction Interval Coverage Probability) PICP for selecting the best particle in the population; and
determine the best rule based on PINAW and PICP values.

13. The computing device as claimed in claim 1, wherein the prediction interval calculator module is further configured to:
compute the coverage of each rule in the rule base, wherein the coverage is determined by selecting the part of the train data set that follows the antecedent part of rule;
determine predicted target values Yᵢ* for each sample present in the set using the consequent part of rule;
compute mean (μ) and standard deviation (σ) of all the extracted predicted target value; and
estimate a prediction for output variable of the samples covered by the rule as [(μ−σ), (μ+σ)].

14. The computing device as claimed in claim 1, wherein the ensembling module is further configured to:
eliminate the rules in the rule base with coverage less than one percent of a total number of samples in the entire dataset to form the ensembled rules.
